(19) United States
(12) Patent Application Publication
(10) Pub. No.: US 2015/0037732 A1
(43) Pub. Date: Feb. 5, 2015

(54) METHOD FOR MANUFACTURING PHOTORECEPTOR LAYERS

(71) Applicant: Xerox Corporation, Norwalk, CT (US)

(72) Inventors: Lanhui Zhang, Webster, NY (US); Lin Ma, Pittsford, NY (US)

(73) Assignee: Xerox Corporation, Norwalk, CT (US)

(21) Appl. No.: 13/957,039

(22) Filed: Aug. 1, 2013

(51) Int. Cl. G03G 5/05

(52) U.S. Cl. CPC G03G 5/0525; G03G 5/0589
USPC 430/133; 430/135

(57) ABSTRACT

The present teachings describe a process of forming a charge transport layer (CTL) coating dispersion. The process includes mixing a surfactant and a first organic solvent until the surfactant is completely solubilized. Fluoroplastic particles are added to the solubilized surfactant and first organic solvent while mixing to form a slurry. The slurry includes a particulate solid content of from about 5 weight percent to about 60 weight percent. The process includes mixing a base solution that includes a charge transport material, a binder, an antioxidant and a second organic solvent. The base solution is added to the slurry while mixing to form a CTL pre-mix dispersion.

### BACKGROUND

1. Field of Use

The present disclosure relates to processes for producing charge transport layers for use in photoreceptors.

2. Background

This disclosure relates generally to charge transport layers and a method for efficient manufacturing of such layers.

Dispersions containing solid particulates are required for manufacturing photoreceptors. The improper preparation of dispersions can result in aggregates, typically fluoroplastics such as polytetrafluoroethylene (PTFE), which settle to the bottom of container, feed pipeline, filter, or may clog the processor, for example the mixing apparatus. The formation of aggregates causes the loss of fluoroplastic resulting in deviation of the composition from specification and decrease of processing throughput. This detrimentally impacts performance of the photoreceptor and production efficiency.

There is a need to introduce a more efficient dispersion mixing process.

### SUMMARY

According to an embodiment, there is provided a process of forming a charge transport layer coating dispersion. The process includes mixing a surfactant and a first organic solvent until the surfactant is completely solubilized. Fluroplastic particles are added to the solubilized surfactant and first organic solvent while mixing to form a slurry. The slurry includes a particulate solid content of from about 5 weight percent to about 60 weight percent. The process includes mixing a base solution that includes a charge transport material, a binder, an antioxidant and a second organic solvent. The base solution is added to the slurry while mixing to form a CTL pre-mix dispersion.

According to another embodiment, there is provided a process of forming a charge transport layer. The process includes mixing a surfactant and a first organic solvent until the surfactant is completely solubilized. The process includes adding fluoroplastic particles, the solubilized surfactant and the first organic solvent while mixing to form a slurry. The slurry includes a particulate solid content of from about 5 weight percent to about 60 weight percent. The process includes mixing a base solution including a charge transport material, a binder, an antioxidant and a second solvent. The base solution is added to the slurry while mixing to form a CTL coating dispersion. The CTL coating dispersion is coated on a conductive substrate. The solvent is removed to form a charge transport layer.

According to another embodiment there is disclosed a process of forming a charge transport layer (CTL). The process includes mixing a surfactant and a first organic solvent until the surfactant is completely solubilized. The process includes adding PTFE particles to the solubilized surfactant and the first organic solvent while mixing for a time of from about 8 hours to about 24 hours to form a slurry. The slurry includes a particulate solid content of from about 5 weight percent to about 60 weight percent. A base solution including a charge transport material, a binder, an antioxidant and a second organic solvent is mixed. The base solution is added to the slurry while mixing to form a CTL coating dispersion. The CTL coating dispersion is on a conductive substrate and the solvents are removed to form a charge transport layer.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a cross-sectional view of an imaging member in a drum configuration according to the present embodiments.

FIG. 2 is a cross-sectional view of an imaging member in a belt configuration according to the present embodiments.

It should be noted that some details of the figures have been simplified and are drawn to facilitate understanding of the embodiments rather than to maintain strict structural accuracy, detail, and scale.

### DESCRIPTION OF THE EMBODIMENTS

In the following description, reference is made to the chemical formulas that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean that one or more of the listed items can be selected.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g. −1, −2, −3, −10, −20, −30, etc.

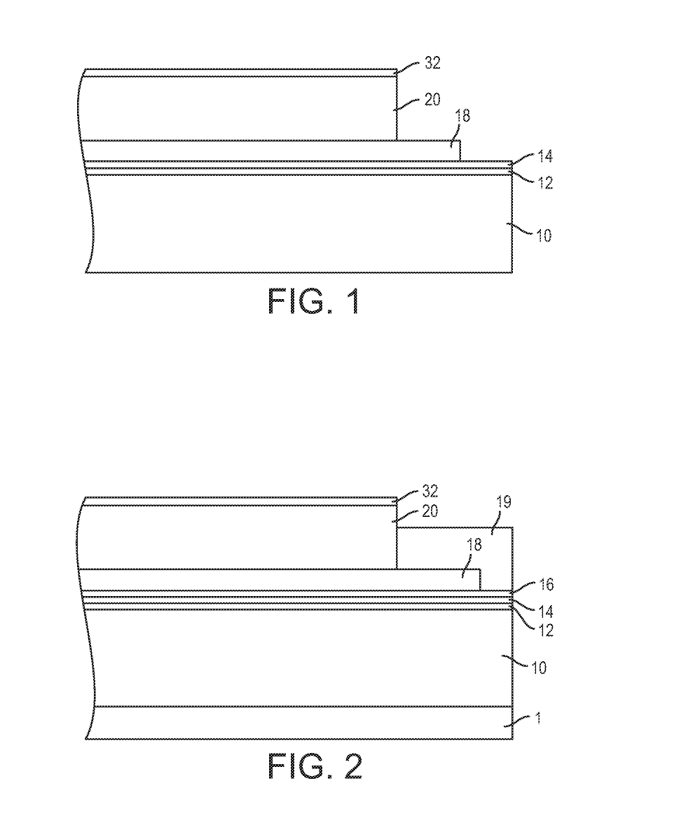

FIG. 1 is an exemplary embodiment of a multilayered electrophotographic imaging member or photoreceptor having a drum configuration. The substrate may further be in a cylinder configuration. As can be seen, the exemplary imaging member includes a rigid support substrate 10, an electrically conductive ground plane 12, an undercoat layer 14, a charge generation layer 18 and a charge transport layer 20. An optional overcoat layer 32 disposed on the charge transport layer 20 may also be included. The substrate 10 may be comprised of a material selected from the group consisting of a metal, metal alloy, aluminum, zirconium, niobium, tantalum, vanadium, hafnium, titanium, nickel, stainless steel, chromium, tungsten, molybdenum, and mixtures thereof. The substrate 10 may also comprise a material selected from the group consisting of a metal, a polymer, a glass, a ceramic, and wood.

The charge generation layer 18 and the charge transport layer 20 form an imaging layer described here as two separate layers. It will be appreciated that the functional components of these layers may alternatively be combined into a single layer.

FIG. 2 shows an imaging member or photoreceptor having a belt configuration according to embodiments. As shown, the belt configuration is provided with an anti-curl back coating 1, a supporting substrate 10, an electrically conductive ground plane 12, an undercoat layer 14, an adhesive layer 16, a charge generation layer 18, and a charge transport layer 20. An optional overcoat layer 32 and ground strip 19 may also be included. An exemplary photoreceptor having a belt configuration is disclosed in U.S. Pat. No. 5,069,993, which is hereby incorporated by reference in its entirety.

A dispersion intermediate used to form a charge transport layer (CTL) is sometimes referred to as a pre-mix. The pre-mix contains fluoroplastic particles, such as polytetrafluoroethylene (PTFE) or perfluoroalkoxy polymer resin (PFA), improve wear on the photoreceptor surface. It is essential that the components in the premix do not vary. When the dispersion formulation is accurate, manufacturing is reliable and performance of the fluoroplastic-CTL is predictable and reliable. Thus, a dispersion preparation that is repeatable with little variation helps ensure the accurate formulation in the final product and reduce or eliminate the issues due to settling. Instead of adding a particulate slurry into a viscous CTL base solution, the new procedure gradually adds a portion or all of the viscous CTL base solution into the particulate slurry and then mixes the blend with the rest of CTL base solution. The same procedure can also be applied to other systems that involve mixing a particulate slurry and a viscous solution.

The fluoroplastic-CTL dispersion preparation includes a step to prepare a “pre-mix”, specifically, to mix the “fluoroplastic/surfactant/solvent slurry” with the “CTL base solution” prior to the further processing.

A fluoroplastic slurry sample is typically prepared by dissolving a fluorinated surfactant in an organic solvent. Fluoroplastic powder is then added to the solubilized surfactant solution. Examples of fluoroplastics include polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer.

Non-limiting examples of the fluorinated surfactant can include poly(fluoroacrylate)-graft-poly(methyl methacrylate) surfactant, fluorinated acrylate copolymer with pendant glycol and/or perfluoroalkyl sulfonate groups surfactant, polyether copolymers with pendant trifluoroethoxy group surfactant, and the like, or combinations thereof. For example, the poly(fluoroacrylate)-graft-poly(methyl methacrylate) surfactant can have weight average molecular weight of about 25,000 or higher. Commercially available products for the fluorinated surfactants can include, for example, GF-300 or GF-400 available from Toagosei Chemical Industry Co., Ltd. Another suitable commercial methacrylate-based fluorinated surfactant or fluorosurfactant product can include, for example, Fluor N 489 by Cytonix Corp., a methacrylate fluorosurfactant. Others can include GF-150 from Tongosei Chemical Industries; MODIPER F-600 from Nippon Oil & Fats Company; SURFLON S-381 and S-382 from Asahi Glass Company; FC-430, FC-4430, FC-4432 and FC-129 from 3M; etc.

Solvents for the fluoroplastic slurry may include tetrahydrofuran (THF), toluene (TOL), N-butyl acetate, xylene, monochlorbenzene, methylene chloride, cyclohexanone, methyl ethyl ketone, methyl isobutyl ketone, polyvinyl ketone and the like, and mixtures thereof.

A CTL base solution is typically prepared by mixing a charge transport material, a binder polymer, an antioxidant, and an organic solvent. The fluoroplastic slurry is then added to the CTL base solution. This is referred to as the pre-mix. The pre-mix is kept on a roller or agitated with a stirrer to ensure good mixing until it is further processed.

Specific examples of polymer binder materials for the CTL solution include polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins and (poly(4,4′-dihydroxy-diphenyl-1-1-cyclohexane).

Charge transport materials used in the CTL solution include N,N′-diphenyl-N,N′-bis(alkylphenyl)-[1,1′-biphenyl]-4,4′-diamine, N,N′-diphenyl-N,N′-bis(3″-methylphenyl)-[1,1′-biphenyl]-4,4′-diamine, N,N′-diphenyl-N,N′-bis(4-methylphenyl)-[1,1′-biphenyl]-4,4′-diamine, N,N′-diphenyl-N,N′-bis(2-methylphenyl)-[1,1′-biphenyl]-4,4′-diamine, N,N′-diphenyl-N,N′-bis(3-ethylphenyl)-[1,1′-biphenyl]-4,4′-diamine, N,N′-diphenyl-N,N′-bis(4-ethylphenyl)-[1,1′-biphenyl]-4,4′-diamine, N,N′-diphenyl-N,N′-bis(4-n-butylphenyl)-[1,1′-biphenyl]-4,4′-diamine, N,N′-diphenyl-N,N′-bis(3chlorophenyl)-[1,1′-biphenyl]-4,4′-diamine, N,N′-diphenyl-N,N′-bis(4-chlorophenyl)-[1,1′-biphenyl]-4,4′-diamine, N,N′-diphenyl-N,N′-bis(phenylmethyl)-[1,1′-biphenyl]-4,4′-diamine, N,N,N′,N′-tetraphenyl-[2,2′-dimethyl-1,1′-biphenyl]-4,4′-diamine, N,N,N′,N′-tetra(4-methylphenyl)-[2,2′-dimethyl-1,1′-biphenyl]-4,4′-diamine, N,N′-diphenyl-N,N′-bis(4-methylphenyl)-[2,2′-dimethyl-1,1′-biphenyl]-4,-4′-diamine, N,N′-diphenyl-N,N′-bis(2-methylphenyl)-[2,2′-dimethyl-1,1′-biphenyl]-4,4′-diamine, N,N′-diphenyl-N,N′-bis(3-methylphenyl)-[2,2′-dimethyl-1,1′-biphe-nyl]-4,4′-diamine, N,N′-diphenyl-N,N′-bis(3-methylphenyl)-pyrenyl-1,6-diamine, 1-[lepidyl-(2)]-3-(p-diethylaminophenyl)-5-(p-diethylaminophenyl)pyrazoli-ne, 1-[quinolyl-(2)]-3-(p-diethylaminophenyl)-5-(p-diethylaminophenyl)pyra-zoline, 1-[pyridyl-(2)]-3-(p-diethylaminostyryl)-5-(p-diethylaminophenyl)p-yrazoline, 1-[6-methoxypyridyl-(2)]-3-(p-diethylaminostyryl)-5-(p-diethyla-minophenyl) pyrazoline, 1-phenyl-3-[p-dimethylaminostyryl]-5-(p-dimethylaminostyryl)pyrazoline and 1-phenyl-3-[p-diethylaminostyryl]-5-(p-diethylaminostyryl)pyrazoline.

Solvents for the CTL solution may include tetrahydrofuran, toluene, N-butyl acetate, xylene, monochlorbenzene, methylene chloride, cyclohexanone, methyl ethyl ketone, methyl isobutyl ketone, polyvinyl ketone and the like, and mixtures thereof. The solvents can be the same or different as used in the PTFE slurry.

Antioxidants used in the CTL solution include phenolic antioxidants, hindered phenolic antioxidants, thioether antioxidants, other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like.

By following the procedure described above, PTFE aggregates can form which settle to the bottom of container or the feed pipeline or filter prior to further processing. The formation of these PTFE aggregates can cause the loss of PTFE; it appears as the composition deviation and fluctuation from the formula in the final products, and thereafter the final product performance variation such as wear resistance. The formation of aggregates also affects the efficiency of subsequent processing, such as filtering, further mixing and coating.

Disclosed herein is a process to prepare a pre-mix for manufacturing a charge transport layer. Instead of adding a slurry into viscous CTL base solution, some or all of the viscous CTL base solution is gradually added into the thin slurry first while stirrer is on and then the blend is mixed with the rest of CTL base solution. The CTL base solution addition can be continuous or stepwise feed.

The PTFE slurry is formed by dissolving a surfactant in a solvent and then adding PTFE particles while mixing. The mixing can be done by a homogenizer, pulverizer, a cavitation mixer available from Five Star Technology or a high shear mixer available from Silverson. The dissolving of the surfactant can be accomplished with gentler mixing. The mixture of solubilized surfactant, solvent and PTFE particles form a slurry having a particulate solid content of from about 5 weight percent to about 60 weight percent, or in embodiments from about 10 weight percent to about 50 weight percent or from about 20 weight percent to about 40 weight percent.

The time of mixing varies from about 8 hours to about 24 hours or from about 10 hours to about 22 hours or from about 12 hours to about 20 hours. The mixing allows the surfactant to adsorb onto fluoroplastic particle surface in the organic solvent. The adsorption of the surfactant can be checked quantitatively by measuring the free surfactant concentration change before and after adsorption. The initial surfactant concentration, C_{suf,0}, is calculated from the formulation,

$${C}_{surf , 0} = \frac{{W}_{surf , 0}}{{W}_{solv , 0}} ,$$

where W_{surf,0} and W_{solv,0} are the initial weight amount of surfactant and solvent. After adsorption, the particles and adsorbed surfactant are removed by centrifugation and then the concentration of the free surfactant in the supernatant, C_{suf,} can be measured by weighing the residual particles after completely removing solvent from a given amount of the supernatant, i.e.,

$${C}_{surf} = \frac{{W}_{res}}{{W}_{sup} - {W}_{res}} ,$$

where Wₛᵤₚ and Wres are the weight amount of supernatant to be dried and its residual after completely removing the solvent. Then, the adsorption, Γ, can be calculated by

$$Γ = \frac{{C}_{surf , 0} - {C}_{surf}}{{C}_{particle , 0}} ,$$

where

$${C}_{particle , 0} = \frac{{W}_{particle , 0}}{{W}_{solv , 0}}$$

is the initial particle concentration, W_{particle,0} and W_{solv,0} are the initial weight amount of particles and solvent, respectively. By measuring a set of adsorptions at different initial concentrations of either or both of surfactant and particles, the maximum adsorption, θₘₐₓ, can be calculated by fitting the well-known Langmuir adsorption equation

$$Γ = \frac{{KC}_{surf}}{1 + {KC}_{surf}} \cdot {Γ}_{max} ,$$

where K is a constant related to the properties of particle, surfactant and solvent. As such, the coverage of surfactant on particles of a specific particle-surfactant-solvent mixture can be described by the ratio

$$\frac{Γ}{{Γ}_{max}} .$$

For example, in a test on a slurry comprising PTFE, GF400 and toluene, the adsorptions of GF400 are listed in below Table 1. The maximum adsorption is found as 0.0387 g/g solvent though Langmuir equation fitting. In one of applications, which slurry comprising 4 g PTFE, 9.33 g solvent, and 0.12 g GF400, the coverage of surfactant on particles,

$$\frac{Γ}{{Γ}_{max}} ,$$

can be calculated as 71%.

TABLE 1

| ID (PTFE/ | W_{particle, 0} | w_{solv, 0} | W_{surf, 0} | Wₛᵤₚ | Wᵣₑₛ | Γ |
|---|---|---|---|---|---|---|
| GF400/TOL) | (g) | (g) | (g) | (g) | (g) | (g/g solv.) |
| A1 | 4.00 | 9.34 | 0.060 | 7.04 | 0.0016 | 0.0143 |
| A2 | 4.00 | 9.34 | 0.079 | 7.42 | 0.0030 | 0.0189 |
| A3 | 4.00 | 9.35 | 0.100 | 7.23 | 0.0045 | 0.0235 |
| A4 | 4.00 | 9.33 | 0.120 | 7.50 | 0.0078 | 0.0277 |
| A5 | 4.00 | 9.35 | 0.121 | 7.47 | 0.0079 | 0.0277 |
| A12 | 4.00 | 9.34 | 0.142 | 7.49 | 0.0145 | 0.0310 |
| A13 | 4.00 | 9.34 | 0.167 | 7.42 | 0.0233 | 0.0345 |
| A14 | 4.00 | 9.34 | 0.251 | 6.91 | 0.0638 | 0.0411 |

The coverage of surfactant on particles range from about 45 percent to about 100 percent of the maximum adsorption.

The CTL base solution can be characterized by percent solids, density, viscosity, refractive index. Please see below for examples. The CTL base solution has a percent solids of from about 15 weight percent to about 35 weight percent, or in embodiments from about 17 weight percent to about 30 weight percent, or from about 22 weight percent to about 29 weight percent. The viscosity of the CTL base solution is from about 40 mPa-s to about 2000 mPa-s, or in embodiments from about 90 mPa-s to about 1500 mPa-s, or from about 100 mPa-s to about 1000 mPa-s at 25° C. The density of the CTL base solution is from about 0.90 g/mL to about 0.98 g/mL, or in embodiments from about 0.91 g/mL to about 0.97 g/mL, or from about 0.92 g/mL to about 0.97 g/mL at 20° C.

After preparing the pre-mix the dispersion is filtered. The pre-mix is processed through a filter having a pore size of from about 40 μm to about 200 μm and then processed again, for example, by CaviPro™ high shear mixer or nanomizer. The processed dispersion is filtered thorough a filter having a pore size of about 15 μm to about 80 μm prior to coating.

It is not necessary to add all of CTL base solution to the slurry in the initial mixing. In practice, only part of the CTL base solution need be added into the slurry while mixing applied and then adding the mixture back to the rest of CTL base solution. As long as the slurry has be diluted with sufficient amount of base solution, the rest of the CTL base solution can be blended with the mixed slurry prior to further processing.

Solvents may include tetrahydrofuran (THF), toluene (TOL), N-butyl acetate, xylene, monochlorbenzene, methylene chloride, cyclohexanone, methyl ethyl ketone, methyl isobutyl ketone, polyvinyl ketone and the like, and mixtures thereof. The solvents for the slurry and CTL base solution can be the same or different.

### Charge Generation Layer

Examples of charge generating pigments include, for example, inorganic photoconductive materials such as amorphous selenium, trigonal selenium, and selenium alloys selected from the group consisting of selenium-tellurium, selenium-tellurium-arsenic, selenium arsenide and mixtures thereof, and organic photoconductive materials including various phthalocyanine pigments such as the X-form of metal free phthalocyanine, metal phthalocyanines such as vanadyl phthalocyanine and copper phthalocyanine, hydroxy gallium phthalocyanines, chlorogallium phthalocyanines, titanyl phthalocyanines, quinacridones, dibromo anthanthrone pigments, benzimidazole perylene, substituted 2,4-diamino-triazines, polynuclear aromatic quinones, enzimidazole perylene, and the like, and mixtures thereof, dispersed in a film forming polymeric binder. Selenium, selenium alloy, benzimidazole perylene, and the like and mixtures thereof may be formed as a continuous, homogeneous charge generation layer. Benzimidazole perylene compositions are well known and described, for example, in U.S. Pat. No. 4,587,189, the entire disclosure thereof being incorporated herein by reference.

Any suitable inactive resin materials may be employed as a binder in the charge generation layer 18, including those described, for example, in U.S. Pat. No. 3,121,006, the entire disclosure thereof being incorporated herein by reference. Organic resinous binders include thermoplastic and thermosetting resins such as one or more of polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins, and the like. Another film-forming polymer binder is PCZ-400 (poly(4,4′-dihydroxy-diphenyl-1-1-cyclohexane) which has a viscosity-molecular weight of 40,000 and is available from Mitsubishi Gas Chemical Corporation (Tokyo, Japan).

Any suitable solvent or solvent mixtures may be employed to form a coating solution for the solid pigment and binder dispersion. Solvents may include tetrahydrofuran, toluene, N-butyl acetate, xylene, monochlorbenzene, methylene chloride, cyclohexanone, methyl ethyl ketone, methyl isobutyl ketone, polyvinyl ketone and the like, and mixtures thereof.

The charge generating material can be present in the resinous binder composition in various amounts. Generally, at least about 5 percent by volume, or no more than about 90 percent by volume of the charge generating material is dispersed in at most about 95 percent by volume, or no less than about 10 percent by volume of the resinous binder, and more specifically at least about 20 percent, or no more than about 60 percent by volume of the charge generating material is dispersed in at most about 80 percent by volume, or no less than about 40 percent by volume of the resinous binder composition.

Any suitable and conventional technique may be utilized to apply the charge generation layer mixture to the supporting substrate layer. The charge generation layer may be formed in a single coating step or in multiple coating steps. Dip coating, ring coating, spray, gravure or any other drum coating methods may be used.

Drying of the deposited coating may be effected by any suitable conventional technique such as oven drying, infrared radiation drying, air drying and the like. The thickness of the charge generation layer is about 0.1 μm, or no more than about 5 μm, for example, from about 0.2 μm to about 3 μm or from about 0.25 μm to about 2.5 μm when dry. Higher binder content compositions generally employ thicker layers for charge generation.

### Charge Transport Layer

PTFE, (polytetrafluoroethylene), is an inert substance that when combined with the charge transport layer reduces the wear rate and greatly extends the life of a photoreceptor. The PTFE slurry described previously is used to manufacture the charge transport layer 20.

The charge transport layer 20 may include any suitable charge transport component or activating compound useful as an additive dissolved or molecularly dispersed in an electrically inactive polymeric material, such as a polycarbonate binder, to form a solid solution and thereby making this material electrically active. “Dissolved” refers, for example, to forming a solution in which the small molecule is dissolved in the polymer to form a homogeneous phase; and molecularly dispersed in embodiments refers, for example, to charge transporting molecules dispersed in the polymer, the small molecules being dispersed in the polymer on a molecular scale. The charge transport component may be added to a film forming polymeric material which is otherwise incapable of supporting the injection of photogenerated holes from the charge generation material and incapable of allowing the transport of these holes. This addition converts the electrically inactive polymeric material to a material capable of supporting the injection of photogenerated holes from the charge generation layer 18 and capable of allowing the transport of these holes through the charge transport layer 20 in order to discharge the surface charge on the charge transport layer. The high mobility charge transport component may comprise small molecules of an organic compound which cooperate to transport charge between molecules and ultimately to the surface of the charge transport layer, for example, but not limited to, N,N′-diphenyl-N,N-bis(3-methyl phenyl)-1,1′-biphenyl-4,4′-diamine (TPD), other arylamines like triphenyl amine, N,N,N′,N′-tetra-p-tolyl-1,1′-biphenyl-4,4′-diamine (TM-TPD), and the like.

Any suitable charge transporting or electrically active molecules known to those skilled in the art may be employed as hole transport molecules (HTMs) in forming a charge transport layer on a photoreceptor. Suitable charge transport compounds include, for example, pyrazolines as described in U.S. Pat. Nos. 4,315,982, 4,278,746, 3,837,851, and 6,214,514, the entire disclosures of each of which are incorporated by reference herein. Suitable pyrazoline charge transport compounds include 1-[lepidyl-(2)]-3-(p-diethylaminophenyl)-5-(p-diethylaminophenyl)pyrazoli-ne, 1-[quinolyl-(2)]-3-(p-diethylaminophenyl)-5-(p-diethylaminophenyl)pyra-zoline, 1-[pyridyl-(2)]-3-(p-diethylaminostyryl)-5-(p-diethylaminophenyl)p-yrazoline, 1-[6-methoxypyridyl-(2)]-3-(p-diethylaminostyryl)-5-(p-diethyla-minophenyl) pyrazoline, 1-phenyl-3-[p-dimethylaminostyryl]-5-(p-dimethylaminostyryl)pyrazoline, 1-phenyl-3-[p-diethylaminostyryl]-5-(p-diethylaminostyryl)pyrazoline, and the like.

A number of charge transport compounds can be included in the charge transport layer, which layer generally is of a thickness of from about 5 to about 75 micrometers, and more specifically, of a thickness of from about 15 to about 40 micrometers. Examples of charge transport components are aryl amines of the following formulas/structures:

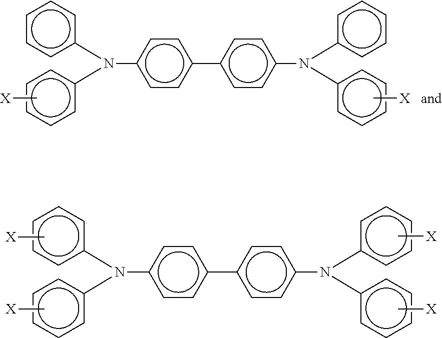

wherein X is a suitable hydrocarbon like alkyl, alkoxy, aryl, and derivatives thereof; a halogen, or mixtures thereof, and especially those substituents selected from the group consisting of Cl and CH₃; and molecules of the following formulas

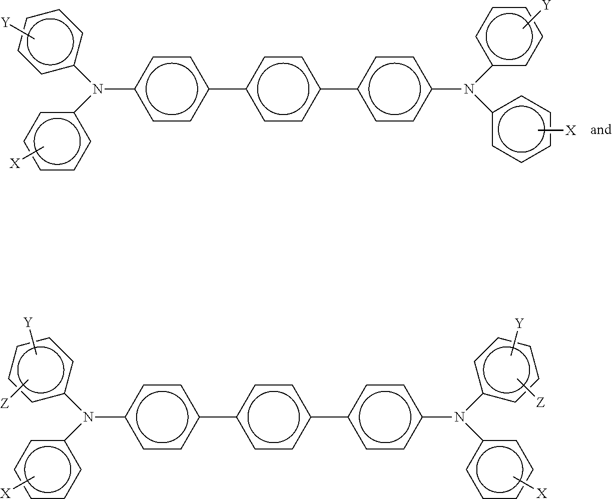

wherein X, Y and Z are independently alkyl, alkoxy, aryl, a halogen, or mixtures thereof, and wherein at least one of Y and Z are present.

Alkyl and alkoxy contain, for example, from 1 to about 25 carbon atoms, and more specifically, from 1 to about 12 carbon atoms, such as methyl, ethyl, propyl, butyl, pentyl, and the corresponding alkoxides. Aryl can contain from 6 to about 36 carbon atoms, such as phenyl, and the like. Halogen includes chloride, bromide, iodide, and fluoride. Substituted alkyls, alkoxys, and aryls can also be selected in embodiments.

Examples of specific aryl amines that can be selected for the charge transport layer include N,N′-diphenyl-N,N′-bis(alkylphenyl)-1,1-biphenyl-4,4′-diamine wherein alkyl is selected from the group consisting of methyl, ethyl, propyl, butyl, hexyl, and the like; N,N′-diphenyl-N,N′-bis(halophenyl)-1,1′-biphenyl-4,4′-diamine wherein the halo substituent is a chloro substituent; N,N′-bis(4-butylphenyl)-N,N′-di-p-tolyl-[p-terphenyl]-4,4″-diamine, N,N′-bis(4-butylphenyl)-N,N′-di-m-tolyl-[p-terphenyl]-4,4″-diamine, N,N′-bis(4-butylphenyl)-N,N′-di-o-tolyl[p-terphenyl]-4,4″-diamine, N,N′-bis(4-butylphenyl)-N,N′-bis-(4-isopropylphenyl)-[p-terphenyl]-4,4″-diamine, N,N′-bis(4-butylphenyl)-N,N′-bis-(2-ethyl-6-methylphenyl)-[p-terphenyl]-4,4″-diamine, N,N′-bis(4-butylphenyl)-N,N′-bis-(2,5-dimethylphenyl)-[p-terphenyl]-4,4′-diamine, N,N′-diphenyl-N,N′-bis(3-chlorophenyl)-[p-terphenyl]-4,4″-diamine, and the like. Other known charge transport layer molecules may be selected in embodiments, for example, U.S. Pat. Nos. 4,921,773 and 4,464,450, the disclosures of which are totally incorporated herein by reference in their entirety.

Examples of the binder materials selected for the charge transport layers include components described previously in and used in the CTL base solution. In embodiments, the charge transport layer, such as a hole transport layer, may have a thickness of at least about 10 μm, or no more than about 40 μm.

Examples of components or materials optionally incorporated into the charge transport layers or at least one charge transport layer to, for example, enable improved lateral charge migration (LCM) resistance include hindered phenolic antioxidants such as tetrakis methylene(3,5-di-tert-butyl-4-hydroxy hydrocinnamate) methane (IRGANOX® 1010, available from Ciba Specialty Chemical), butylated hydroxytoluene (BHT), and other hindered phenolic antioxidants including SUMILIZER™ BHT-R, MDP-S, BBM-S, WX-R, NW, BP-76, BP-101, GA-80, GM and GS (available from Sumitomo Chemical Co., Ltd.), IRGANOX® 1035, 1076, 1098, 1135, 1141, 1222, 1330, 1425WL, 1520L, 245, 259, 3114, 3790, 5057 and 565 (available from Ciba Specialties Chemicals), and ADEKA STAB™ AO-20, AO-30, AO-40, AO-50, AO-60, AO-70, AO-80 and AO-330 (available from Asahi Denka Co., Ltd.); hindered amine antioxidants such as SANOL™ LS-2626, LS-765, LS-770 and LS-744 (available from SANKYO CO., Ltd.), TINUVIN® 144 and 622LD (available from Ciba Specialties Chemicals), MARK™ LA57, LA67, LA62, LA68 and LA63 (available from Asahi Denka Co., Ltd.), and SUMILIZER® TPS (available from Sumitomo Chemical Co., Ltd.); thioether antioxidants such as SUMILIZER® TP-D (available from Sumitomo Chemical Co., Ltd); phosphite antioxidants such as MARK™ 2112, PEP-8, PEP-24G, PEP-36, 329K and HP-10 (available from Asahi Denka Co., Ltd.); other molecules such as bis(4-diethylamino-2-methylphenyl)phenylmethane (BDETPM), bis-[2-methyl-4-(N-2-hydroxyethyl-N-ethyl-aminophenyl)]-phenylmethane (DHTPM), and the like. The weight percent of the antioxidant in at least one of the charge transport layer is from about 0 to about 20, from about 1 to about 10, or from about 2 to about 8 weight percent.

Any suitable solvent or solvent mixtures may be employed to form a coating solution for the charge transport dispersion containing PTFE and binder. Solvents may include tetrahydrofuran, toluene, N-butyl acetate, xylene, monochlorbenzene, methylene chloride, cyclohexanone, and the like, and mixtures thereof.

The charge transport layer should be an insulator to the extent that the electrostatic charge placed on the hole transport layer is not conducted in the absence of illumination at a rate sufficient to prevent formation and retention of an electrostatic latent image thereon. The charge transport layer is substantially nonabsorbing to visible light or radiation in the region of intended use, but is electrically “active” in that it allows the injection of photogenerated holes from the photoconductive layer, that is the charge generation layer, and allows these holes to be transported through itself to selectively discharge a surface charge on the surface of the active layer.

In addition, in the present embodiments using a belt configuration, the charge transport layer may consist of a single pass charge transport layer or a dual pass charge transport layer (or dual layer charge transport layer) with the same or different transport molecule ratios. In these embodiments, the dual layer charge transport layer has a total thickness of from about 10 μm to about 40 μm. In other embodiments, each layer of the dual layer charge transport layer may have an individual thickness of from about 2 μm to about 20 μm. Moreover, the charge transport layer may be configured such that it is used as a top layer of the photoreceptor to inhibit crystallization at the interface of the charge transport layer and the overcoat layer. In another embodiment, the charge transport layer may be configured such that it is used as a first pass charge transport layer to inhibit microcrystallization occurring at the interface between the first pass and second pass layers.

Any suitable and conventional technique may be utilized to apply the charge transport layer mixture to the supporting substrate layer. The charge transport layer may be formed in a single coating step or in multiple coating steps. Dip coating, ring coating, spray, gravure or any other drum coating methods or any belt or flat sheet coating methods may be used.

Drying of the deposited coating may be effected by any suitable conventional technique such as oven drying, infrared radiation drying, air drying and the like. The thickness of the charge transport layer after drying is from about 10 μm to about 40 μm or from about 12 μm to about 36 μm for optimum photoelectrical and mechanical results. In another embodiment the thickness is from about 14 μm to about 36 μm.

### The Overcoat Layer

Other layers of the imaging member may include, for example, an optional over coat layer 32. An optional overcoat layer 32, if desired, may be disposed over the charge transport layer 20 to provide imaging member surface protection as well as improve resistance to abrasion. In embodiments, the overcoat layer 32 may have a thickness ranging from about 0.1 micrometer to about 25 micrometers or from about 1 micrometer to about 10 micrometers, or in a specific embodiment, about 3 micrometers to about 10 micrometers. These overcoat layers typically comprise a charge transport component and an optional organic polymer or inorganic polymer. These overcoat layers may include thermoplastic organic polymers or cross-linked polymers such as thermosetting resins, UV or e-beam cured resins, and the likes. The overcoat layers may further include a particulate additive such as metal oxides including aluminum oxide and silica, or low surface energy polytetrafluoroethylene (PTFE), and combinations thereof.

Any known or new overcoat materials may be included for the present embodiments. In embodiments, the overcoat layer may include a charge transport component or a cross-linked charge transport component. In particular embodiments, for example, the overcoat layer comprises a charge transport component comprised of a tertiary arylamine containing substituent capable of self cross-linking or reacting with the polymer resin to form a cured composition. Specific examples of charge transport component suitable for overcoat layer comprise the tertiary arylamine with a general formula of

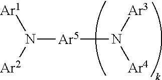

wherein Ar¹, Ar², Ar³, and Ar⁴ each independently represents an aryl group having about 6 to about 30 carbon atoms, Ar⁵ represents aromatic hydrocarbon group having about 6 to about 30 carbon atoms, and k represents 0 or 1, and wherein at least one of Ar¹, Ar², Ar³ Ar⁴, and Ar⁵ comprises a substituent selected from the group consisting of hydroxyl (—OH), a hydroxymethyl (—CH₂OH), an alkoxymethyl (—CH₂OR, wherein R is an alkyl having 1 to about 10 carbons), a hydroxylalkyl having 1 to about 10 carbons, and mixtures thereof. In other embodiments, Ar¹, Ar², Ar³, and Ar⁴ each independently represent a phenyl or a substituted phenyl group, and Ar^{y} represents a biphenyl or a terphenyl group.

Additional examples of charge transport component which comprise a tertiary arylamine include the following:

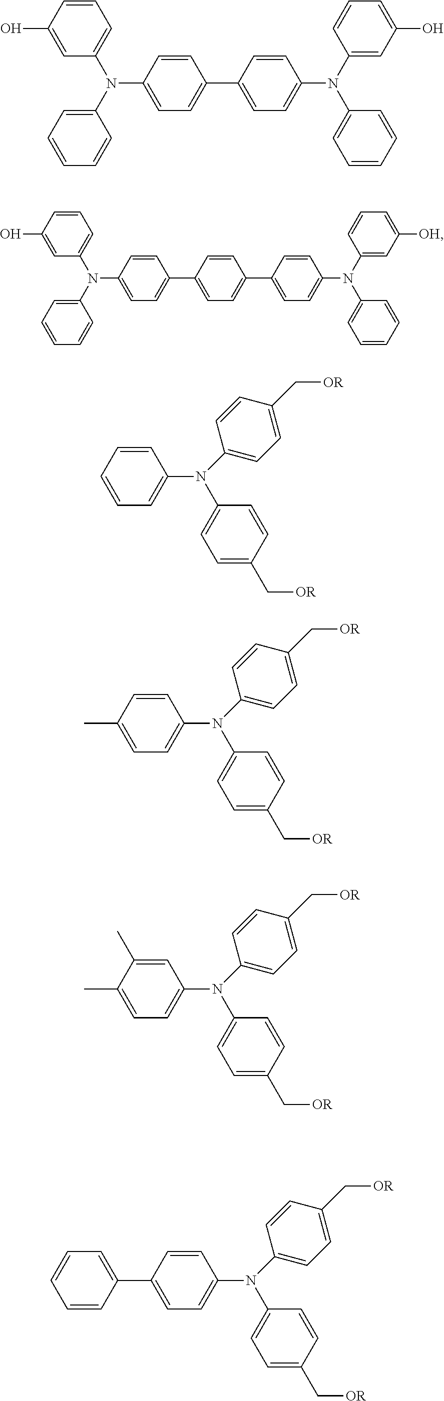

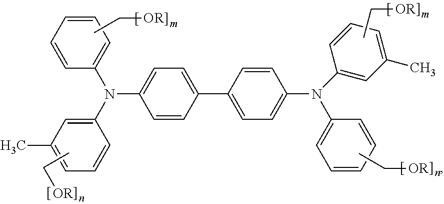

and the like, wherein R is a substituent selected from the group consisting of hydrogen atom, and an alkyl having from 1 to about 6 carbons, and m and n each independently represents 0 or 1, wherein m+n>1. In specific embodiments, the overcoat layer may include an additional curing agent to form a cured, crosslinked overcoat composition. Illustrative examples of the curing agent may be selected from the group consisting of a melamine-formaldehyde resin, a phenol resin, an isocyanate or a masking isocyanate compound, an acrylate resin, a polyol resin, or mixtures thereof. In embodiments, the crosslinked overcoat composition has an average modulus ranging from about 3 GPa to about 5 GPa, as measured by nano-indentation method using, for example, nanomechanical test instruments manufactured by Hysitron Inc. (Minneapolis, Minn.).

### The Substrate

The photoreceptor support substrate 10 may be opaque or substantially transparent, and may comprise any suitable organic or inorganic material having the requisite mechanical properties. The entire substrate can comprise the same material as that in the electrically conductive surface, or the electrically conductive surface can be merely a coating on the substrate. Any suitable electrically conductive material can be employed, such as for example, metal or metal alloy. Electrically conductive materials include copper, brass, nickel, zinc, chromium, stainless steel, conductive plastics and rubbers, aluminum, semitransparent aluminum, steel, cadmium, silver, gold, zirconium, niobium, tantalum, vanadium, hathium, titanium, nickel, niobium, stainless steel, chromium, tungsten, molybdenum, paper rendered conductive by the inclusion of a suitable material therein or through conditioning in a humid atmosphere to ensure the presence of sufficient water content to render the material conductive, indium, tin, metal oxides, including tin oxide and indium tin oxide, and the like. It could be single metallic compound or dual layers of different metals and/or oxides.

The substrate 10 can also be formulated entirely of an electrically conductive material, or it can be an insulating material including inorganic or organic polymeric materials, such as MYLAR, a commercially available biaxially oriented polyethylene terephthalate from DuPont, or polyethylene naphthalate available as KALEDEX 2000, with a ground plane layer 12 comprising a conductive titanium or titanium/zirconium coating, otherwise a layer of an organic or inorganic material having a semiconductive surface layer, such as indium tin oxide, aluminum, titanium, and the like, or exclusively be made up of a conductive material such as, aluminum, chromium, nickel, brass, other metals and the like. The thickness of the support substrate depends on numerous factors, including mechanical performance and economic considerations.

The substrate 10 may have a number of many different configurations, such as for example, a plate, a cylinder, a drum, a scroll, an endless flexible belt, and the like. In the case of the substrate being in the form of a belt, as shown in FIG. 2, the belt can be seamed or seamless. In embodiments, the photoreceptor herein is in a drum configuration.

The thickness of the substrate 10 depends on numerous factors, including flexibility, mechanical performance, and economic considerations. The thickness of the support substrate 10 of the present embodiments may be at least about 500 micrometers, or no more than about 3,000 micrometers, or be at least about 750 micrometers, or no more than about 2500 micrometers.

An exemplary support substrate 10 is not soluble in any of the solvents used in each coating layer solution, is optically transparent or semi-transparent, and is thermally stable up to a high temperature of about 150° C. A support substrate 10 used for imaging member fabrication may have a thermal contraction coefficient ranging from about 1×10⁻⁵ per ° C. to about 3×10⁻⁵ per ° C. and a Young's Modulus of between about 5×10⁻⁵ psi (3.5×10⁻⁴ Kg/cm²) and about 7×10⁻⁵ psi (4.9×10⁻⁴ Kg/cm²).

### The Ground Plane

The electrically conductive ground plane 12 may be an electrically conductive metal layer which may be formed, for example, on the substrate 10 by any suitable coating technique, such as a vacuum depositing technique. Metals include aluminum, zirconium, niobium, tantalum, vanadium, hafnium, titanium, nickel, stainless steel, chromium, tungsten, molybdenum, and other conductive substances, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be at least about 20 Angstroms, or no more than about 750 Angstroms, or at least about 50 Angstroms, or no more than about 200 Angstroms for an optimum combination of electrical conductivity, flexibility and light transmission.

Regardless of the technique employed to form the metal layer, a thin layer of metal oxide forms on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as a transparent layer for light having a wavelength between about 4000 Angstroms and about 9000 Angstroms or a conductive carbon black dispersed in a polymeric binder as an opaque conductive layer.

### The Hole Blocking Layer

After deposition of the electrically conductive ground plane layer, the hole blocking layer 14 may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutyral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylamino-ethylamino)titanate, isopropyl trianthranil titanate, isopropyl tri(N,N-dimethylethylamino)titanate, titanium-4-amino benzene sulfonate oxyacetate, titanium 4-aminobenzoate isostearate oxyacetate, [H₂N(CH₂)₄]CH₃Si(OCH₃)₂, (gamma-aminobutyl) methyl diethoxysilane, and [H₂N(CH₂)₃]CH₃Si(OCH₃)₂ (gamma-aminopropyl) methyl diethoxysilane, as disclosed in U.S. Pat. Nos. 4,338,387, 4,286,033 and 4,291,110.

The hole blocking layer should be continuous and have a thickness of less than about 0.5 micrometer because greater thicknesses may lead to undesirably high residual voltage. A hole blocking layer of between about 0.005 micrometer and about 0.3 micrometer is used because charge neutralization after the exposure step is facilitated and optimum electrical performance is achieved. A thickness of between about 0.03 micrometers and about 0.06 micrometers is used for hole blocking layers for optimum electrical behavior. The hole blocking layers that contain metal oxides such as zinc oxide, titanium oxide, or tin oxide, may be thicker, for example, having a thickness up to about 25 micrometers. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is applied in the form of a dilute solution, with the solvent being removed after deposition of the coating by conventional techniques such as by vacuum, heating and the like. Generally, a weight ratio of hole blocking layer material and solvent of between about 0.05:100 to about 0.5:100 is satisfactory for spray coating.

### The Undercoat Layer

General embodiments of the undercoat layer 14 may comprise a metal oxide and a resin binder. The metal oxides that can be used with the embodiments herein include, but are not limited to, titanium oxide, zinc oxide, tin oxide, aluminum oxide, silicon oxide, zirconium oxide, indium oxide, molybdenum oxide, and mixtures thereof. Undercoat layer binder materials may include, for example, polyesters, MOR-ESTER 49,000 from Morton International Inc., VITEL PE-100, VITEL PE-200, VITEL PE-200D, and VITEL PE-222 from Goodyear Tire and Rubber Co., polyarylates such as ARDEL from AMOCO Production Products, polysulfone from AMOCO Production Products, polyurethanes, and the like.

While embodiments have been illustrated with respect to one or more implementations, alterations and/or modifications can be made to the illustrated examples without departing from the spirit and scope of the appended claims. In addition, while a particular feature herein may have been disclosed with respect to only one of several implementations, such feature may be combined with one or more other features of the other implementations as may be desired and advantageous for any given or particular function.

### EXAMPLES

The following procedure was used to prepare the pre-mix components.

In 16 mL vial, a PTFE slurry sample was prepared by dissolving 0.114 grams GF400 in 3.72 g toluene and adding 3.8 g PTFE powder into the dissolved GF 400 and toluene (PTFE slurry).

A 450 gram CTL base solution was prepared PCZ400/mTBD/BHT in the following solid weight percentages 57/43/1, using THF/TOL=70/30 as the solvent. The resulting mixture has a 24.0 percent solids content by weight. (CTL solution).

### Example 1

The PTFE slurry was poured into 200 grams of CTL solution and the container containing the PTFE slurry was rinsed with 8.68 g THF and added to the CTL Solution (Premix 1. Premix 1 was rolled overnight.

### Example 2

The PTFE slurry was poured into a premix container. The PTFE slurry was rinsed with 8.68 g THF and added to the premix container. 200 g of CTL solution was added to the PTFE slurry in 10 gram segments. After each addition the premix container was shaken. After the 200 grams was added the premix container was rolled overnight.

The premix for Example 1 and Example 2 was poured into a glass container for observation. Aggregates were visible in Example 1 but not with Example 2. The improvement is applicable to plant scale processes minimizing or eliminating the plugging issues. The success was evidenced by no clogging during next step processing and the percent of fluoroplastic particles (PTFE) of the resulting dispersion measured by DSC method meets the formula value.

It will be appreciated that variants of the above-disclosed and other features and functions or alternatives thereof, may be combined into other different systems or applications. Various presently unforeseen or unanticipated alternatives, modifications, variations, or improvements therein may be subsequently made by those skilled the in the art which are also encompassed by the following claims.

1. A process of forming a charge transport layer coating dispersion, the process comprising:
mixing a surfactant and a first organic solvent until the surfactant is completely solubilized;
adding fluoroplastic particles to the surfactant and first organic solvent while mixing to form a slurry wherein the slurry comprises a particulate solid content of from about 5 weight percent to about 60 weight percent of the slurry, wherein a coverage of the surfactant on the fluoroplastic particles ranges from about 45 percent to about 100 percent of a maximum adsorption;
mixing a base solution comprising a charge transport material, a binder, an antioxidant and a second organic solvent; and
adding the base solution to the slurry while mixing to form a charge transport layer pre-mix dispersion.

2. The process of claim 1, further comprising:
processing the pre-mix dispersion to form a coating dispersion.

3. The process according to claim 1, wherein the first organic solvent is selected from the group consisting of: tetrahydrofuran, toluene, N-butyl acetate, xylene, monochlorbenzene, methylene chloride, cyclohexanone, methyl ethyl ketone, methyl isobutyl ketone, polyvinyl ketone and mixtures thereof.

4. The process according to claim 1, wherein the second organic solvent is selected from the group consisting of: tetrahydrofuran, toluene, N-butyl acetate, xylene, monochlorbenzene, methylene chloride, cyclohexanone, methyl ethyl ketone, methyl isobutyl ketone, polyvinyl ketone and mixtures thereof.

5. The process according to claim 1, wherein the first organic solvent and the second organic solvent are the same.

6. The process according to claim 1, wherein the surfactant is selected from the group consisting of: (poly(fluoroacrylate)-graft-poly(methyl methacrylate), fluorinated acrylate copolymer with pendant glycol and/or perfluoroalkyl sulfonate groups and polyether copolymers with pendant trifluoroethoxy groups.

7. The process according to claim 1, wherein the binder is selected from the group consisting of: polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins and (poly(4,4′-dihydroxy-diphenyl-1-1-cyclohexane).

8. The process according to claim 1, wherein the charge transport material is selected from the group consisting of: N,N′-diphenyl-N,N′-bis(alkylphenyl)-[1,1′-biphenyl]-4,4′-diamine, N,N′-diphenyl-N,N′-bis(3″-methylphenyl)-[1,1′-biphenyl]-4,4′-diamine, N,N′-diphenyl-N,N′-bis(4-methylphenyl)-[1,1′-biphenyl]-4,4′-diamine, N,N′-diphenyl-N,N′-bis(2-methylphenyl)-[1,1′-biphenyl]-4,4′-diamine, N,N′-diphenyl-N,N′-bis(3-ethylphenyl)-[1,1′-biphenyl]-4,4′-diamine, N,N′-diphenyl-N,N′-bis(4-ethylphenyl)-[1,1′-biphenyl]-4,4′-diamine, N,N′-diphenyl-N,N′-bis(4-n-butylphenyl)-[1,1′-biphenyl]-4,4′-diamine, N,N′-diphenyl-N,N′-bis(3chlorophenyl)-[1,1′-biphenyl]-4,4′-diamine, N,N′-diphenyl-N,N′-bis(4-chlorophenyl)-[1,1′-biphenyl]-4,4′-diamine, N,N′-diphenyl-N,N′-bis(phenylmethyl)-[1,1′-biphenyl]-4,4′-diamine, N,N,N′,N′-tetraphenyl-[2,2′-dimethyl-1,1′-biphenyl]-4,4′-diamine, N,N,N′,N′-tetra(4-methylphenyl)-[2,2′-dimethyl-1,1′-biphenyl]-4,4′-diamine, N,N′-diphenyl-N,N′-bis(4-methylphenyl)-[2,2′-dimethyl-1,1′-biphenyl]-4,-4′-diamine, N,N′-diphenyl-N,N′-bis(2-methylphenyl)-[2,2′-dimethyl-1,1′-biphenyl]-4,4′-diamine, N,N′-diphenyl-N,N′-bis(3-methylphenyl)-[2,2′-dimethyl-1,1′-biphe-nyl]-4,4′-diamine, N,N′-diphenyl-N,N′-bis(3-methylphenyl)-pyrenyl-1,6-diamine, 1-[lepidyl-(2)]-3-(p-diethylaminophenyl)-5-(p-diethylaminophenyl)pyrazoline, 1-[quinolyl-(2)]-3-(p-diethylaminophenyl)-5-(p-diethylaminophenyl)pyra-zoline, 1-[pyridyl-(2)]-3-(p-diethylaminostyryl)-5-(p-diethylaminophenyl)p-yrazoline, 1-[6-methoxypyridyl-(2)]-3-(p-diethylaminostyryl)-5-(p-diethyla-minophenyl)pyrazoline, 1-phenyl-3-[p-dimethylaminostyryl]-5-(p-dimethylaminostyryl)pyrazoline and 1-phenyl-3-[p-diethylaminostyryl]-5-(p-diethylaminostyryl)pyrazoline.

9. The process according to claim 1, wherein antioxidant is selected from the group consisting of: hindered phenolic antioxidants, hindered amine antioxidants, phosphite antioxidants, bis(4-diethylamino-2-methylphenyl)phenylmethane (BDETPM) and bis-[2-methyl-4-(N-2-hydroxyethyl-N-ethyl-aminophenyl)]-phenylmethane (DHTPM).

10. The process according to claim 1, wherein the fluoroplastic particles are selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), hexafluoropropylene (HFP), and a cure site monomer.

11. A process of forming a charge transport layer (CTL), the process comprising:
mixing a surfactant and a first organic solvent until the surfactant is completely solubilized;
adding fluoroplastic particles, to the solubilized surfactant and the first organic solvent while mixing to form a slurry, wherein the slurry comprises a particulate solid content of from about 5 weight percent to about 60 weight percent, wherein a coverage of the surfactant on the fluoroplastic particles ranges from about 45 percent to about 100 percent of a maximum adsorption;
mixing a base solution comprising a charge transport material, a binder, an antioxidant and a second organic solvent;
adding the base solution to the slurry while mixing to form a CTL coating dispersion;
coating the CTL coating dispersion on a conductive substrate; and
removing the solvents to form a charge transport layer.

12. The process according to claim 11, wherein the first organic solvent is selected from the group consisting of: tetrahydrofuran, toluene, N-butyl acetate, xylene, monochlorbenzene, methylene chloride, cyclohexanone, methyl ethyl ketone, methyl isobutyl ketone, polyvinyl ketone and mixtures thereof.

13. The process according to claim 11, wherein the second organic solvent is selected from the group consisting of: tetrahydrofuran, toluene, N-butyl acetate, xylene, monochlorbenzene, methylene chloride, cyclohexanone, methyl ethyl ketone, methyl isobutyl ketone, polyvinyl ketone and mixtures thereof.

14. (canceled)

15. The process according to claim 11, wherein the surfactant is selected from the group consisting of: (poly(fluoroacrylate)-graft-poly(methyl methacrylate), fluorinated acrylate copolymer with pendant glycol and/or perfluoroalkyl sulfonate groups and polyether copolymers with pendant trifluoroethoxy groups.

16. The process according to claim 11, wherein the binder is selected from the group consisting of: polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl butyral, polyvinyl acetate, polysiloxanes, polyacrylates, polyvinyl acetals, polyamides, polyimides, amino resins, phenylene oxide resins, terephthalic acid resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride/vinylchloride copolymers, vinylacetate/vinylidene chloride copolymers, styrene-alkyd resins and (poly(4,4′-dihydroxy-diphenyl-1-1-cyclohexane).

17. The process according to claim 11, wherein the charge transport material is selected from the group consisting of: N,N′-diphenyl-N,N′-bis(alkylphenyl)-[1,1′-biphenyl]-4,4′-diamine, N,N′-diphenyl-N,N′-bis(3″-methylphenyl)-[1,1′-biphenyl]-4,4′-diamine, N,N′-diphenyl-N,N′-bis(4-methylphenyl)-[1,1′-biphenyl]-4,4′-diamine, N,N′-diphenyl-N,N′-bis(2-methylphenyl)-[1,1′-biphenyl]-4,4′-diamine, N,N′-diphenyl-N,N′-bis(3-ethylphenyl)-[1,1′-biphenyl]-4,4′-diamine, N,N′-diphenyl-N,N′-bis(4-ethylphenyl)-[1,1′-biphenyl]-4,4′-diamine, N,N′-diphenyl-N,N′-bis(4-n-butylphenyl)-[1,1′-biphenyl]-4,4′-diamine, N,N′-diphenyl-N,N′-bis(3chlorophenyl)-[1,1′-biphenyl]-4,4′-diamine, N,N′-diphenyl-N,N′-bis(4-chlorophenyl)-[1,1′-biphenyl]-4,4′-diamine, N,N′-diphenyl-N,N′-bis(phenylmethyl)-[1,1′-biphenyl]-4,4′-diamine, N,N,N′,N′-tetraphenyl-[2,2′-dimethyl-1,1′-biphenyl]-4,4′-diamine, N,N,N′,N′-tetra(4-methylphenyl)-[2,2′-dimethyl-1,1′-biphenyl]-4,4′-diamine, N,N′-diphenyl-N,N′-bis(4-methylphenyl)-[2,2′-dimethyl-1,1′-biphenyl]-4,-4′-diamine, N,N′-diphenyl-N,N′-bis(2-methylphenyl)-[2,2′-dimethyl-1,1′-biphenyl]-4,4′-diamine, N,N′-diphenyl-N,N′-bis(3-methylphenyl)-[2,2′-dimethyl-1,1′-biphe-nyl]-4,4′-diamine, N,N′-diphenyl-N,N′-bis(3-methylphenyl)-pyrenyl-1,6-diamine, 1-[lepidyl-(2)]-3-(p-diethylaminophenyl)-5-(p-diethylaminophenyl)pyrazoli-ne, 1-[quinolyl-(2)]-3-(p-diethylaminophenyl)-5-(p-diethylaminophenyl)pyra-zoline, 1-[pyridyl-(2)]-3-(p-diethylaminostyryl)-5-(p-diethylaminophenyl)p-yrazoline, 1-[6-methoxypyridyl-(2)]-3-(p-diethylaminostyryl)-5-(p-diethyla-minophenyl) pyrazoline, 1-phenyl-3-[p-dimethylaminostyryl]-5-(p-dimethylaminostyryl)pyrazoline and 1-phenyl-3-[p-diethylaminostyryl]-5-(p-diethylaminostyryl)pyrazoline.

18. The process according to claim 11, wherein antioxidant is selected from the group consisting of: hindered phenolic antioxidants, hindered amine antioxidants, phosphite antioxidants, bis(4-diethylamino-2-methylphenyl)phenylmethane (BDETPM) and bis-[2-methyl-4-(N-2-hydroxyethyl-N-ethyl-aminophenyl)]-phenylmethane (DHTPM).

19. The process according to claim 11, wherein the fluoroplastic particles are selected from the group consisting of polytetrafluoroethylene (PTFE); perfluoroalkoxy polymer resin (PFA); copolymers of tetrafluoroethylene (TFE) and hexafluoropropylene (HFP); copolymers of hexafluoropropylene (HFP) and vinylidene fluoride (VDF or VF2); terpolymers of tetrafluoroethylene (TFE), vinylidene fluoride (VDF), and hexafluoropropylene (HFP); and tetrapolymers of tetrafluoroethylene (TFE), vinylidene fluoride (VF2), and hexafluoropropylene (HFP) and a cure site monomer.

20. A process of forming a charge transport layer (CTL), the process comprising:
mixing a surfactant and a first organic solvent until the surfactant is completely solubilized;
adding PTFE particles, to the solubilized surfactant and the first organic solvent while mixing to form a slurry, wherein the slurry comprises a particulate solid content of from about 5 weight percent to about 60 weight percent, wherein a coverage of the surfactant on the fluoroplastic particles ranges from about 45 percent to about 100 percent of a maximum adsorption;
mixing a base solution comprising a charge transport material, a binder, an antioxidant and a second organic solvent;
adding the base solution to the slurry while mixing to form a CTL coating dispersion;
coating the CTL coating dispersion on a conductive substrate; and
removing the solvents to form a charge transport layer.
